(19) United States
(12) Patent Application Publication
(10) Pub. No.: US 2024/0277032 A1
(43) Pub. Date: Aug. 22, 2024

(54) ARTICLE FOR USE IN A NON-COMBUSTIBLE AEROSOL PROVISION SYSTEM

(71) Applicant: Nicoventures Trading Limited, London (GB)

(72) Inventor: Benjamin TAYLOR, London (GB)

(21) Appl. No.: 18/571,337

(22) PCT Filed: Jun. 17, 2022
(86) PCT No.: PCT/GB2022/051527

§ 371 Date: Dec. 18, 2023

(30) Foreign Application Priority Data
Jun. 18, 2021 (GB) 2108772.1

(51) Int. Cl. A24D 1/20; A24C 5/01; A24F 40/20; A24F 40/46; A24F 40/465; H05B 3/42

(52) U.S. Cl. CPC A24D 1/20; A24C 5/01; A24F 40/20; A24F 40/46; A24F 40/465; H05B 3/42

(57) ABSTRACT

An article for use in an aerosol provision system includes a rod of aerosol generating material having a distal end, and a cavity that extends into the rod of aerosol generating material from the distal end. The invention also includes a system having a non-combustible aerosol provision device, and the article for insertion into the non-combustible aerosol provision device. A method of manufacturing the article including a rod of aerosol-generating material includes extruding the aerosol-generating material through a die head and over a mandrel to form a cavity extending through the aerosol-generating material.

### RELATED APPLICATIONS

The present application is a National Phase Entry of PCT Application No. PCT/GB2022/051527 filed Jun. 17, 2022, which claims priority to GB Application No. 2108772.1 filed Jun. 18, 2021, each of which is hereby incorporated by reference in their entirety.

### TECHNICAL FIELD

The present invention relates to an article for use in a non-combustible aerosol provision system, to a system comprising the article and a non-combustible aerosol provision device, and to a method of manufacturing an article according to the invention.

### BACKGROUND

Certain tobacco industry products produce an aerosol during use, which is inhaled by a user. For example, tobacco heating devices heat an aerosol generating substrate such as tobacco to form an aerosol by heating, but not burning, the substrate. Such tobacco industry products commonly include mouthpieces through which the aerosol passes to reach the user's mouth.

### SUMMARY

In accordance with some embodiments described herein, there is provided an article for use in an aerosol provision system, the article comprising a rod of aerosol generating material having a distal end, and a cavity that extends into the rod of aerosol generating material from said distal end.

The cavity may have a longitudinal axis that coaxial with a longitudinal axis of the rod of aerosol-generating material.

The cavity may extend the full length of the rod aerosol-generating material.

The cavity may have a non-circular cross-section.

The cavity may have a non-uniform cross section in a longitudinal direction of the aerosol-generating material. In particular, the cavity may be tapered in a longitudinal direction. The cavity may taper in a direction away from the distal end.

In embodiments of the invention, a material layer lines at least a portion of the cavity.

An aerosol-generating material may be disposed on both surfaces of the material layer such that the material layer is embedded in aerosol-generating material.

The material layer may be a gel, an amorphous solid, or a sheet material such as paper.

In some embodiments, the material layer comprises a heating element. If the material layer comprises a heating element it may be configured to be conductively, or inductively, heated.

An air path may be defined through the heating element, and the heating element may include an array of air apertures. As used herein, the term ‘array of air apertures is intended to mean two or more air apertures/perforations or openings. The array of air apertures may be distributed circumferentially around the heating element. The array of air apertures may be distributed axially along the heating element. At least a first air aperture of the array of air aperture may differ in flow area from at least a second air aperture of the array of air apertures. The flow area of the array of air apertures may increase in a direction from the distal end to the proximal end. The flow area of the array of air apertures may increase in a direction from the proximal end to the distal end. The density of air apertures of the array of air apertures may increase in a direction from the distal end to the proximal end. Density in this context means number of or concentration of air apertures per unit area of the heating element. The density of air apertures of the array of air apertures may decrease in a direction from the distal end to the proximal end. Density in this context means number of or concentration of air apertures per unit area of the heating element. The device may comprise a first wall region of the heating element comprising the array of air apertures, and a second wall region of the heating element free of the array of air apertures. The first region may be a band. The second region may be a band. The air outlet may comprise a mesh. The air outlet may comprise an array of perforations. The air apertures may be elongate. The air apertures may extend in a longitudinal direction of the heating element.

The article may comprise a mouth end opposite to said distal end, said mouth end being configured to be placed between the lips of a user when the distal end is inserted into a non-combustible aerosol provision device.

A cooling segment may be located between the aerosol-generating material and the mouth end.

A filtration segment may be located between the cooling segment and the mouth end.

In accordance with other embodiments described herein, there is provided a system comprising a non-combustible aerosol provision device, and an article comprising a rod of aerosol-generating material having a distal end for insertion into the non-combustible aerosol provision device, wherein a cavity extends into the rod of aerosol-generating material from said distal end.

The article may comprise a material layer that lines at least a portion of the cavity.

Aerosol-generating material may be disposed on both surfaces of the material layer such that the material layer is embedded in aerosol-generating material.

The material layer can be a gel, an amorphous solid, or a sheet such as paper.

The material layer may comprise a heating element.

The aerosol-provision device may comprise a heater configured to extend into the cavity in the rod of aerosol-generating material through said distal end when the article is received in the aerosol-provision device.

The heating element and the cavity may each have the same cross-sectional shape.

The heating element may be a snug or interference fit in the cavity.

The heating element may be a susceptor and the aerosol-provision device may comprise a magnetic field generator that surrounds the aerosol-generating material when the article is inserted into the device to inductively heat the heating element.

The material layer may be permeable to air and can be a mesh, or be perforated or have openings.

In accordance with some other embodiments described herein, there is provided a method of manufacturing an article comprising a rod of aerosol-generating material having a distal end for insertion into a non-combustible aerosol provision device, the method comprising extruding the aerosol-generating material through a die head and over a mandrel to form a cavity extending through the aerosol-generating material.

The mandrel may be shaped to provide a correspondingly shaped cavity in the aerosol-generating material.

A material layer may be drawn over the mandrel and the aerosol-generating material extruded over the material layer.

In accordance with some other embodiments described herein, there is provided a method of manufacturing an aerosol-generating section of an article for use in a aerosol-provision system, the aerosol-generating section comprising a rod of aerosol generating material wrapped in a material layer and comprising a cavity lined with a material layer, the method comprising:
providing a material layer sheet;
pressing the material layer sheet into a mold in the shape of an aerosol-generating section including an upstanding former, so that the material layer sheet conforms to the shape of the mold and surrounds the former;
filling the mold with aerosol generating material,
pressing the aerosol-generating material into the mold to form the aerosol-generating section, and
releasing the aerosol-generating section from the mold.

The method may comprise cutting an end of the article to separate the material layer wrapping the article from the material layer lining the cavity.

In accordance with some other embodiments described herein, there is provided a method of manufacturing an aerosol-generating section of an article for use in an aerosol-provision system, the aerosol-generating section comprising a rod of aerosol generating material wrapped in a material layer and comprising a cavity, the method comprising:
providing a material layer sheet;
pressing the material layer sheet into a mold in the shape of an aerosol-generating article so that the material layer sheet conforms to the shape of the mold;
filling the mold with aerosol generating material,
spinning the mold to generate centrifugal force sufficient to urge the aerosol-generating material radially outward and against an inner wall of the mold to form a central cavity, and
releasing the article from the mold.

### BRIEF DESCRIPTION OF THE DRAWINGS

Embodiments of the invention will now be described, by way of example only, with reference to accompanying drawings, in which:

FIG. 1a is a side-on cross sectional view of an article for use with a non-combustible aerosol provision device;

FIG. 1b is a side-on cross sectional view of an article for use with a non-combustible aerosol provision device according to another embodiment;

FIGS. 2a to 2c each show a different embodiment of a cross-section through the aerosol-generating material of the article of FIG. 1, taken along line A-A;

FIG. 3a to 3c each show a different embodiment of a cross section through the aerosol-generating material of the article of FIG. 2, taken along line A-A;

FIG. 4 is a cross sectional view of a non-combustible aerosol provision device;

FIG. 5 is a simplified schematic of the components within the housing of the aerosol provision device shown in FIG. 4;

FIG. 6 is a cross sectional view of the non-combustible aerosol provision device shown in FIG. 4 with the article shown in FIG. 1 or 2 inserted into the device; and

FIG. 7 shows another embodiment of a non-combustible aerosol-provision device 200 for use with the article of FIG. 1b.

### DETAILED DESCRIPTION

As used herein, the term “delivery system” is intended to encompass systems that deliver at least one substance to a user, and includes:
combustible aerosol provision systems, such as cigarettes, cigarillos, cigars, and tobacco for pipes or for roll-your-own or for make-your-own cigarettes (whether based on tobacco, tobacco derivatives, expanded tobacco, reconstituted tobacco, tobacco substitutes or other smokable material);
non-combustible aerosol provision systems that release compounds from an aerosol-generating material without combusting the aerosol-generating material, such as electronic cigarettes, tobacco heating products, and hybrid systems to generate aerosol using a combination of aerosol-generating materials; and
aerosol-free delivery systems that deliver the at least one substance to a user orally, nasally, transdermally or in another way without forming an aerosol, including but not limited to, lozenges, gums, patches, articles comprising inhalable powders, and oral products such as oral tobacco which includes snus or moist snuff, wherein the at least one substance may or may not comprise nicotine.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device, and a consumable for use with the non-combustible aerosol provision device.

The disclosure relates to consumables comprising aerosol-generating material and configured to be used with non-combustible aerosol provision devices. These consumables are sometimes referred to as articles throughout the disclosure.

The terms ‘upstream’ and ‘downstream’ used herein are relative terms defined in relation to the direction of mainstream aerosol drawn through an article or device in use. Reference to the ‘distal end’ refers to an upstream end of the device, whereas ‘proximal end’ refers to the downstream end of the device.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energised so as to distribute power in the form of heat to an aerosol-generating material or to a heat transfer material in proximity to the exothermic power source.

In some embodiments, the non-combustible aerosol provision system comprises an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

The consumable comprises a substance to be delivered. The substance to be delivered is an aerosol-generating material. As appropriate, the material may comprise one or more active constituents, one or more flavors, one or more aerosol-former materials, and/or one or more other functional materials.

In some embodiments, the substance to be delivered comprises an active substance. The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical. In some embodiments, the active substance comprises nicotine. In some embodiments, the active substance comprises caffeine, melatonin or vitamin B12.

As noted herein, the active substance may comprise or be derived from one or more botanicals or constituents, derivatives or extracts thereof. As used herein, the term “botanical” includes any material derived from plants including, but not limited to, extracts, leaves, bark, fibers, stems, roots, seeds, flowers, fruits, pollen, husk, shells or the like. Alternatively, the material may comprise an active compound naturally existing in a botanical, obtained synthetically. The material may be in the form of liquid, gas, solid, powder, dust, crushed particles, granules, pellets, shreds, strips, sheets, or the like. Example botanicals are tobacco, eucalyptus, star anise, hemp, cocoa, cannabis, fennel, lemongrass, peppermint, spearmint, rooibos, chamomile, flax, ginger, Ginkgo biloba, hazel, hibiscus, laurel, licorice (liquorice), matcha, mate, orange skin, papaya, rose, sage, tea such as green tea or black tea, thyme, clove, cinnamon, coffee, aniseed (anise), basil, bay leaves, cardamom, coriander, cumin, nutmeg, oregano, paprika, rosemary, saffron, lavender, lemon peel, mint, juniper, elderflower, vanilla, wintergreen, beefsteak plant, curcuma, turmeric, sandalwood, cilantro, bergamot, orange blossom, myrtle, cassis, valerian, pimento, mace, damien, marjoram, olive, lemon balm, lemon basil, chive, carvi, verbena, tarragon, geranium, mulberry, ginseng, theanine, theacrine, maca, ashwagandha, damiana, guarana, chlorophyll, baobab or any combination thereof. The mint may be chosen from the following mint varieties: Mentha arventis, Mentha c.v., Mentha niliaca, Mentha piperita, Mentha piperita citrata c.v., Mentha piperita c.v, Mentha spicata crispa, Mentha cardifolia, Mentha longifolia, Mentha suaveolens variegata, Mentha pulegium, Mentha spicata c.v. and Mentha suaveolens.

In some embodiments, the active substance comprises or is derived from one or more botanicals or constituents, derivatives or extracts thereof and the botanical is tobacco.

In some embodiments, the active substance comprises or derived from one or more botanicals or constituents, derivatives or extracts thereof and the botanical is selected from eucalyptus, star anise, cocoa and hemp.

In some embodiments, the active substance comprises or derived from one or more botanicals or constituents, derivatives or extracts thereof and the botanical is selected from rooibos and fennel.

In some embodiments, the substance to be delivered comprises a flavor.

As used herein, the terms “flavor” and “flavorant” refer to materials which, where local regulations permit, may be used to create a desired taste, aroma or other somatosensorial sensation in a product for adult consumers. They may include naturally occurring flavor materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, Ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gas.

In some embodiments, the flavor comprises menthol, spearmint and/or peppermint. In some embodiments, the flavor comprises flavor components of cucumber, blueberry, citrus fruits and/or redberry. In some embodiments, the flavor comprises eugenol. In some embodiments, the flavor comprises flavor components extracted from tobacco. In some embodiments, the flavor comprises flavor components extracted from cannabis.

In some embodiments, the flavor may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucolyptol, WS-3.

An aerosol-generating material is a material that is capable of generating aerosol, for example when heated, irradiated or energized in any other way. An aerosol-generating material may be in the form of a solid, liquid or gel which may or may not contain an active substance and/or flavorants. The aerosol-generating material is incorporated into an article for use in the aerosol-generating system.

As used herein, the term “tobacco material” refers to any material comprising tobacco or derivatives or substitutes thereof. The tobacco material may be in any suitable form. The term “tobacco material” may include one or more of tobacco, tobacco derivatives, expanded tobacco, reconstituted tobacco or tobacco substitutes. The tobacco material may comprise one or more of ground tobacco, tobacco fiber, cut tobacco, extruded tobacco, tobacco stem, tobacco lamina, reconstituted tobacco and/or tobacco extract.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, in particular a heating element, that emits heat to cause the aerosol-generating material to generate aerosol in use. The heater may, comprise, a material heatable by electrical conduction, or a susceptor.

A susceptor is a material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The device that is configured to generate the varying magnetic field is referred to as a magnetic field generator, herein.

An aerosol-modifying agent is a substance, typically located downstream of the aerosol generation area, that is configured to modify the aerosol generated, for example by changing the taste, flavor, acidity or another characteristic of the aerosol. The aerosol-modifying agent may be provided in an aerosol-modifying agent release component, that is operable to selectively release the aerosol-modifying agent.

The aerosol-modifying agent may, for example, be an additive or a sorbent. The aerosol-modifying agent may, for example, comprise one or more of a flavorant, a colorant, water, and a carbon adsorbent. The aerosol-modifying agent may, for example, be a solid, a liquid, or a gel. The aerosol-modifying agent may be in powder, thread or granule form. The aerosol-modifying agent may be free from filtration material.

An aerosol-generating device is an apparatus configured to cause aerosol to be generated from the aerosol-generating material. The aerosol generating device comprises a heater configured to subject the aerosol-generating material to heat energy, so as to release one or more volatiles from the aerosol-generating material to form an aerosol.

The filamentary tow material described herein can comprise cellulose acetate fiber tow. The filamentary tow can also be formed using other materials used to form fibers, such as polyvinyl alcohol (PVOH), polylactic acid (PLA), polycaprolactone (PCL), poly(1-4 butanediol succinate) (PBS), poly(butylene adipate-co-terephthalate) (PBAT), starch based materials, cotton, aliphatic polyester materials and polysaccharide polymers or a combination thereof. The filamentary tow may be plasticised with a suitable plasticiser for the tow, such as triacetin where the material is cellulose acetate tow, or the tow may be non-plasticised. The tow can have any suitable specification, such as fibers having a ‘Y’ shaped or other cross section such as ‘X’ shaped, filamentary denier values between 2.5 and 15 denier per filament, for example between 8.0 and 11.0 denier per filament and total denier values of 5,000 to 50,000, for example between 10,000 and 40,000.

In the figures described herein, like reference numerals are used to illustrate equivalent features, articles or components.

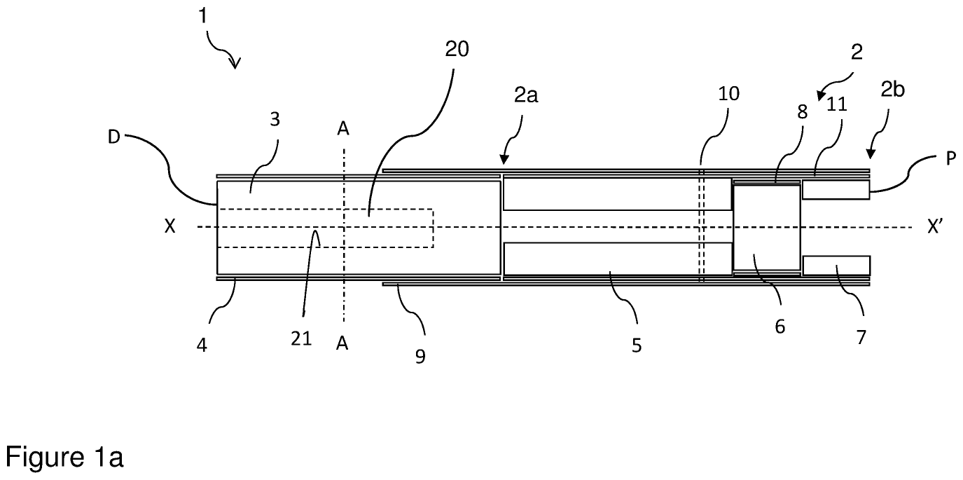

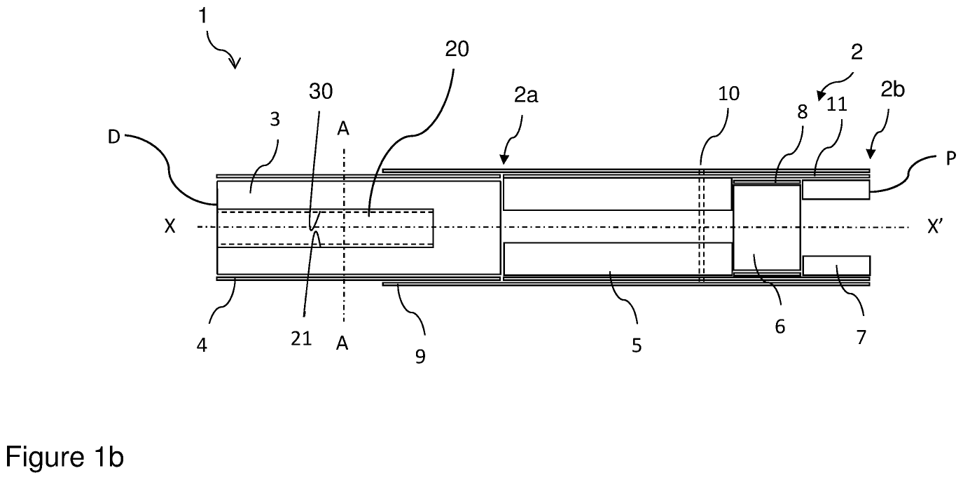

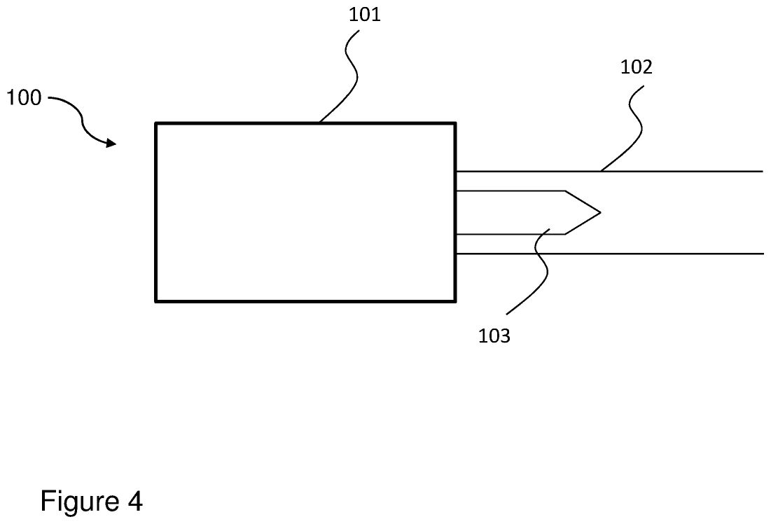

FIG. 1 is a side-on cross sectional view of an article 1 for use in an aerosol delivery system that includes an aerosol delivery device 100 (see FIGS. 4 to 6).

The article 1 has an upstream or distal end ‘D’ and a downstream or proximal end ‘P’. The proximal end P comprises a mouthpiece 2, and the distal end D comprises an aerosol-generating section, connected to the mouthpiece 2. In the present example, the aerosol generating section comprises a source of aerosol-generating material 3 in the form of a rod. The aerosol-generating material 3 may comprise a plurality of strands or strips of aerosol-generating material 3. For example, the aerosol-generating material 3 may comprise a plurality of strands or strips of an aerosolizable material and/or a plurality of strands or strips of an amorphous solid.

In the present example, the aerosol-generating material 3 comprises a plurality of strands and/or strips of aerosol-generating material, and is circumscribed by a wrapper 4. In the present example, the wrapper 4 is a moisture impermeable wrapper.

The plurality of strands or strips of aerosol-generating material 3 may be aligned within the aerosol-generating section such that their longitudinal dimension is in parallel alignment with the longitudinal axis, X-X′ of the article 1. Alternatively, the strands or strips may generally be arranged such that their longitudinal dimension aligned is transverse to the longitudinal axis of the article 1.

In the present example, the rod of aerosol-generating material 3 has a circumference of about 22.7 mm. In alternative embodiments, the rod of aerosol-generating material 3 may have any suitable circumference, for example between about 20 mm and about 26 mm.

The article 1 is configured for use in a non-combustible aerosol provision device 100 (see FIG. 4) comprising an aerosol generator in the form of a heating element 103, such as a blade or pin, for insertion into the aerosol generating material 3 of the aerosol-generating section, as will be described in more detail below.

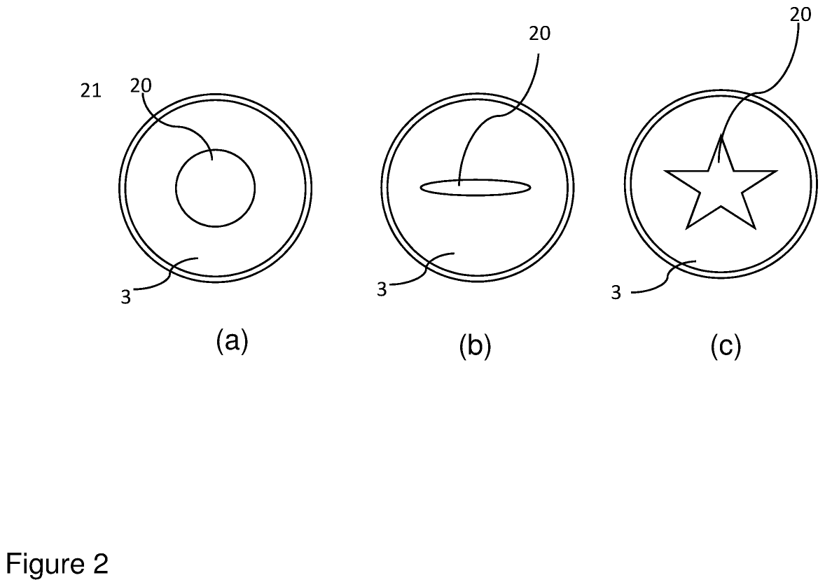

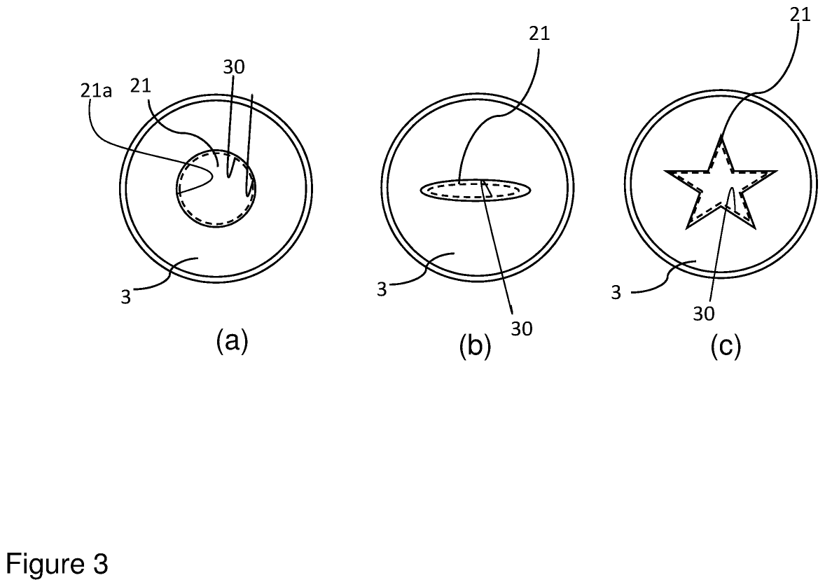

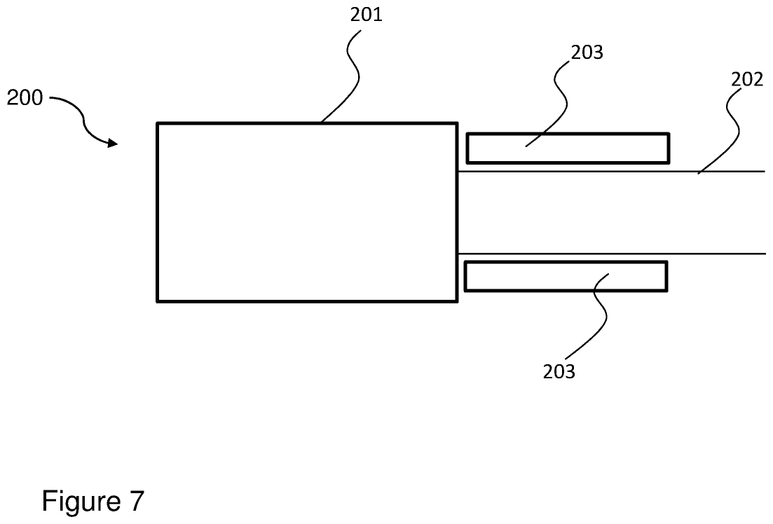

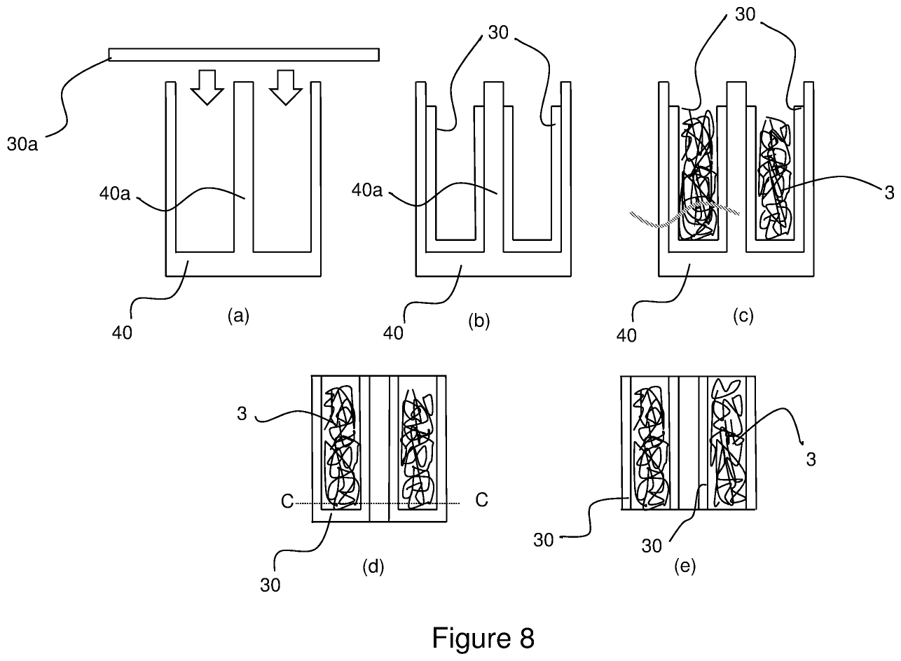

In other embodiments, to be described in more detail below with reference to FIG. 2, and FIGS. 3a to 3c, a heating element 30 is incorporated into the aerosol-generating material 3 of the article 1 and forms an integral component of the article 1. In such embodiments, the heating element 30 may be a susceptor. If the heating element 30 is a susceptor, the device 200 can comprise a magnetic field generator 203 that surrounds the aerosol-generating material 3 to inductively heat the heating element 30 which, in turn, heats the aerosol-generating material 3. Such a device 200 is shown in FIG. 7.

The mouthpiece 2 includes a cooling section 5, also referred to as a cooling element, positioned immediately downstream of and adjacent to the source of aerosol-generating material 3. In the present example, the cooling section 5 is in an abutting relationship with the source of aerosol-generating material 3. The mouthpiece 2 also includes, in the present example, a body of material 6 downstream of the cooling section 5, and a hollow tubular element 7 downstream of the body of material 6, at the mouth end 2 of the article 1.

The cooling section 5 comprises a hollow channel, having an internal diameter of between about 1 mm and about 4 mm, for example between about 2 mm and about 4 mm. In the present example, the hollow channel has an internal diameter of about 3 mm. The hollow channel extends along the full length of the cooling section 5. In the present example, the cooling section 5 comprises a single hollow channel. In alternative embodiments, the cooling section can comprise multiple channels, for example, 2, 3 or 4 channels. In the present example, the single hollow channel is substantially cylindrical, although in alternative embodiments, other channel geometries/cross-sections may be used. The hollow channel can provide a space into which aerosol drawn into the cooling section 5 can expand and cool down. In all embodiments, the cooling section 5 is configured to limit the cross-sectional area of the hollow channel/s, to limit tobacco displacement into the cooling section 5, in use.

The moisture impermeable wrapper 4 can have a lower friction with the aerosol-generating material 3, which can result in strands and/or strips of aerosol-generating material 3 being more easily displaced longitudinally, into the cooling section 5, when the heating element 103 is inserted into the rod of aerosol-generating material 3. By providing a cooling section 5 directly adjacent to the source of aerosol generating material 3, and comprising an inner channel with a diameter in this range, the longitudinal displacement of strands and/or strips of aerosol-generating material 3 when the heating element 103 of the device 100 is inserted into the rod of aerosol-generating material 3 is reduced. Reducing the displacement of aerosol-generating material 3, in use, can advantageously result in a more consistent packing density of aerosol-generating material 3 along the length of the rod, which can result in more consistent and improved aerosol generation.

In examples, the cooling section 5 has a wall thickness in a radial direction. The wall thickness of the cooling section 5, for a given outer diameter of cooling section, defines the internal diameter for the chamber surrounded by the walls of the cooling section 5. The cooling section 5 can have a wall thickness of at least about 1.5 mm and up to about 2 mm. In the present example, the cooling section 5 has a wall thickness of about 2 mm. By providing a cooling section 5 having a wall thickness within this range retention of the source of aerosol-generating material 3 in the aerosol generating section is improved, in use, by reducing the longitudinal displacement of strands and/or strips of aerosol-generating material 3 when the aerosol generator is inserted into the article 1.

The cooling section 5 is formed from filamentary tow. Other constructions can be used, such as a plurality of layers of paper which are parallel wound, with butted seams, to form the cooling section 5; or spirally wound layers of paper, cardboard tubes, tubes formed using a papier-mâché type process, molded or extruded plastic tubes or similar. The cooling section 5 is manufactured to have a rigidity that is sufficient to withstand the axial compressive forces and bending moments that might arise during manufacture and whilst the article 1 is in use.

The wall material of the cooling section 5 can be relatively non-porous, such that at least 90% of the aerosol generated by the aerosol generating material 3 passes longitudinally through the one or more hollow channels rather than through the wall material of the cooling section 5. For instance, at least 92% or at least 95% of the aerosol generated by the aerosol generating material 3 can pass longitudinally through the one or more hollow channels.

In examples, the mouthpiece 2 comprises a cavity having an internal volume greater than 110 mm³. Providing a cavity of at least this volume has been found to enable the formation of an improved aerosol. The mouthpiece 2 comprises a cavity, for instance formed within the cooling section 5, having an internal volume greater than 110 mm³, and greater than 130 mm³, allowing further improvement of the aerosol. In some examples, the internal cavity comprises a volume of between about 130 mm³ and about 230 mm³, for instance about 134 mm³ or 227 mm³.

The cooling section 5 can be configured to provide a temperature differential of at least 40 degrees Celsius between a heated volatilized component entering a first, upstream end of the cooling section 5 and a heated volatilized component exiting a second, downstream end of the cooling section 5. The cooling section 5 may be configured to provide a temperature differential of at least 60 degrees Celsius, or at least 80 degrees Celsius, or at least 100 degrees Celsius between a heated volatilized component entering a first, upstream end of the cooling section 5 and a heated volatilized component exiting a second, downstream end of the cooling section 5. This temperature differential across the length of the cooling section 8 protects the temperature sensitive body of material 6 from the high temperatures of the aerosol-generating material 3 when it is heated.

When in use, the aerosol-generating section may exhibit a pressure drop of from about 15 to about 40 mm H₂O. In some embodiments, the aerosol-generating section exhibits a pressure drop across the aerosol-generating section of from about 15 to about 30 mm H₂O.

In the present embodiment, the moisture impermeable wrapper 4 which circumscribes the rod of aerosol-generating material 3 comprises aluminium foil. In other embodiments, the wrapper 4 comprises a paper wrapper, optionally comprising a barrier coating to make the material of the wrapper 4 substantially moisture impermeable. Aluminium foil has been found to be particularly effective at enhancing the formation of aerosol within the aerosol-generating material 3. In the present example, the aluminium foil has a metal layer having a thickness of about 6 μm. In the present example, the aluminium foil has a paper backing. However, in alternative arrangements, the aluminium foil can be other thicknesses, for instance between 4 μm and 16 μm in thickness. The aluminium foil also need not have a paper backing, but could have a backing formed from other materials, for instance to help provide an appropriate tensile strength to the foil, or it could have no backing material. Metallic layers or foils other than aluminium can also be used. The total thickness of the wrapper may be between 20 μm and 60 μm, or between 30 μm and 50 μm, which can provide a wrapper having appropriate structural integrity and heat transfer characteristics. The tensile force which can be applied to the wrapper before it breaks can be greater than 3,000 grams force, for instance between 3,000 and 10,000 grams force or between 3,000 and 4,500 grams force. Where the wrapper comprises paper or a paper backing, i.e. a cellulose based material, the wrapper can have a basis weight greater than about 30 gsm. For example, the wrapper 4 can have a basis weight in the range from about 40 gsm to about 70 gs, which can provide an improved rigidity to the rod of aerosol-generating material 3. The improved rigidity provided by wrappers 4 having a basis weight in this range can make the rod of aerosol-generating material 3 more resistant to crumpling or other deformation under the forces to which the article is subject, in use, for example when the article is inserted into a device and/or a heat generator is inserted into the article 1.

In the present example, the moisture impermeable wrapper 4 is also substantially impermeable to air. In alternative embodiments, the wrapper 4 may have a permeability of less than 100 Coresta Units, or less than 60 Coresta Units. It has been found that low permeability wrappers, for instance having a permeability of less than 100 Coresta Units, or less than 60 Coresta Units, result in an improvement in the aerosol formation in the aerosol-generating material 3. Without wishing to be bound by theory, it is hypothesized that this is due to reduced loss of aerosol compounds through the wrapper 10. The permeability of the wrapper 10 can be measured in accordance with ISO 2965:2009 concerning the determination of air permeability for materials used as cigarette papers, filter plug wrap and filter joining paper.

The body of material 6 defines a substantially cylindrical overall outer shape and is wrapped in a first plug wrap 8. The first plug wrap 8 may have a basis weight of less than 50 gsm, or between about 20 gsm and 40 gsm. The first plug wrap 8 may have a thickness of between 30 μm and 60 μm, or between 35 μm and 45 μm. The first plug wrap 8 may be a non-porous plug wrap, for instance having a permeability of less than 100 Coresta units, for instance less than 50 Coresta units. However, in other embodiments, the first plug wrap 8 can be a porous plug wrap, for instance having a permeability of greater than 200 Coresta Units.

As shown in FIG. 1, the mouthpiece 2 of the article 1 comprises an upstream end 2a adjacent to the rod of aerosol-generating material 3. At the proximal end, the mouthpiece 2 has a hollow tubular element 7 formed from filamentary tow. This has advantageously been found to significantly reduce the temperature of the outer surface of the mouthpiece 2 at the downstream end 2b of the mouthpiece which comes into contact with a consumer's mouth when the article 1 is in use. In addition, the use of the tubular element 7 has also been found to significantly reduce the temperature of the outer surface of the mouthpiece 2 even upstream of the tubular element 7. Without wishing to be bound by theory, it is hypothesized that this is due to the tubular element 7 channeling aerosol closer to the centre of the mouthpiece 2, and therefore reducing the transfer of heat from the aerosol to the outer surface of the mouthpiece 2.

The “wall thickness” of the hollow tubular element 7 corresponds to the thickness of the wall of the tube 7 in a radial direction. This may be measured, for example, using a caliper. The wall thickness is advantageously greater than 0.9 mm, or 1.0 mm or greater. The wall thickness may be substantially constant around the entire wall of the hollow tubular element 7. However, where the wall thickness is not substantially constant, the wall thickness can be greater than 0.9 mm at any point around the hollow tubular element 7, or 1.0 mm or greater. In the present example, the wall thickness of the hollow tubular element 4 is about 1.3 mm.

A tipping paper 9 is wrapped around the full length of the mouthpiece 2 and over part of the rod of aerosol-generating material 3 and has an adhesive on its inner surface to connect the mouthpiece 2 and rod 3. In the present example, the rod of aerosol-generating material 3 is wrapped in wrapper 4, which forms a first wrapping material, and the tipping paper 9 forms an outer wrapping material which extends at least partially over the rod of aerosol-generating material 3 to connect the mouthpiece 2 and rod 3. In some examples, the tipping paper 9 can extend only partially over the rod of aerosol-generating material 3.

The article 1 has a ventilation level of about 10% of the aerosol drawn through the article 1. In alternative embodiments, the article 1 can have a ventilation level of between 1% and 20% of aerosol drawn through the article 1, for instance between 1% and 12%. Ventilation at these levels helps to increase the consistency of the aerosol inhaled by the user at the mouth end 2b, while assisting the aerosol cooling process. The ventilation is provided directly into the mouthpiece 2 of the article 1. In the present example, the ventilation is provided into the cooling section 5, which has been found to be particularly beneficial in assisting with the aerosol generation process. The ventilation is provided via perforations 10, in the present case formed as a single row of laser perforations, positioned 13 mm from the downstream, mouth-end 2b of the mouthpiece 2. In alternative embodiments, two or more rows of ventilation perforations 10 may be provided. These perforations 10 pass though the tipping paper 9, second plug wrap 11 and cooling section 5. In alternative embodiments, the ventilation can be provided into the mouthpiece 2 at other locations, for instance into the body of material 6 or first tubular element 7. The article 1 may be configured such that the perforations 10 are provided about 28 mm or less from the upstream end of the article 1, or between 20 mm and 28 mm from the upstream end of the article 1. In the present example, the apertures are provided about 25 mm from the upstream end of the article 1.

The aerosol-generating material 3 comprises a plant-based material, such as tobacco material. The aerosol-generating material 3 may be a sheet or shredded sheet of aerosolizable material comprising a plant-based material, such as tobacco material.

The plant-based material may be a particulate or granular material. In some embodiments, the plant-based material o material is a powder. Alternatively or in addition, the tobacco material may comprise may comprise strips, strands or fibers of tobacco. For example, the tobacco material may comprise particles, granules, fibers, strips and/or strands of tobacco. In some embodiments, the tobacco material consists of particles or granules of tobacco material.

The density of the tobacco material has an impact on the speed at which heat conducts through the material, with lower densities, for instance those below 900 mg/cc, conducting heat more slowly through the material, and therefore enabling a more sustained release of aerosol.

The tobacco material can comprise reconstituted tobacco material having a density of less than about 900 mg/cc, for instance paper reconstituted tobacco material. For instance, the aerosol-generating material comprises reconstituted tobacco material having a density of less than about 800 mg/cc. Alternatively, or in addition, the aerosol-generating material can comprise reconstituted tobacco material having a density of at least 350 mg/cc.

The tobacco material may comprise tobacco obtained from any part of the tobacco plant. In some embodiments, the tobacco material comprises tobacco leaf.

The sheet or shredded sheet can comprise from 5% to about 90% by weight tobacco leaf.

The aerosol-generating material 3 may comprise an aerosol-former material. The aerosol-former material comprises one or more constituents capable of forming an aerosol. The aerosol-former material comprises one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate. The aerosol-former material may be glycerol or propylene glycol.

The sheet or shredded sheet of aerosolizable material comprises an aerosol-former material. The aerosol-former material is provided in an amount of up to about 50% on a dry weight base by weight of the sheet or shredded sheet. In some embodiments, the aerosol former material is provided in an amount of from about 5% to about 40% on a dry weight base by weight of the sheet or shredded sheet, from about 10% to about 30% on a dry weight base by weight of the sheet or shredded sheet or from about 10% to about 20% on a dry weight base by weight of the sheet or shredded sheet.

The aerosol-generating material 3 may comprise a filler. In some embodiments, the sheet or shredded sheet comprises the filler. The filler is generally a non-tobacco component, that is, a component that does not include ingredients originating from tobacco. The filler may comprise one or more inorganic filler materials, such as calcium carbonate, perlite, vermiculite, diatomaceous earth, colloidal silica, magnesium oxide, magnesium sulphate, magnesium carbonate, and suitable inorganic sorbents, such as molecular sieves. The filler may be a non-tobacco fiber such as wood fiber or pulp or wheat fiber. The filler can be a material comprising cellulose or a material comprises a derivate of cellulose. The filler component may also be a non-tobacco cast material or a non-tobacco extruded material.

The aerosol-generating material 3 herein can comprise an aerosol modifying agent, such as any of the flavors described herein. In one embodiment, the aerosol-generating material 3 comprises menthol. When the aerosol-generating material 3 is incorporated into an article 1 for use in an aerosol-provision system, the article may be referred to as a mentholated article 1. The aerosol-generating material 3 can comprise from 0.5 mg to 20 mg of menthol, from 0.7 mg to 20 mg of menthol, between 1 mg and 18 mg or between 8 mg and 16 mg of menthol.

In some embodiments, the composition comprises an aerosol-forming “amorphous solid”, which may alternatively be referred to as a “monolithic solid” (i.e. non-fibrous). In some embodiments, the amorphous solid may comprise a dried gel. The amorphous solid is a solid material that may retain some fluid, such as liquid, within it.

In some examples, the amorphous solid comprises:
1-60 wt % of a gelling agent;
0.1-50 wt % of an aerosol-former material; and
0.1-80 wt % of a flavor;
   wherein these weights are calculated on a dry weight basis.

In some further embodiments, the amorphous solid comprises:
1-50 wt % of a gelling agent;
0.1-50 wt % of an aerosol-former material; and
30-60 wt % of a flavor;
   wherein these weights are calculated on a dry weight basis.

The amorphous solid material may be provided in sheet or in shredded sheet form. The amorphous solid material may take the same form as the sheet or shredded sheet of aerosolizable material.

The aerosol-generating material 3 can comprise a paper reconstituted tobacco material. The composition can alternatively or additionally comprise any of the forms of tobacco described herein. The aerosol generating material 3 can comprise a sheet or shredded sheet comprising tobacco material comprising between 10% and 90% by weight tobacco leaf, wherein an aerosol-former material is provided in an amount of up to about 20% by weight of the sheet or shredded sheet, and the remainder of the tobacco material comprises paper reconstituted tobacco.

Where the aerosol-generating material 3 comprises an amorphous solid material, the amorphous solid material may be a dried gel comprising menthol.

In FIG. 4, the components of an embodiment of a non-combustible aerosol provision device 100, according to an embodiment of the invention, are shown in a simplified manner. Particularly, the elements of the non-combustible aerosol provision device 100 are not drawn to scale in FIG. 4. Elements that are not relevant for the understanding of this embodiment have been omitted to simplify FIG. 4.

As shown in FIG. 4, the non-combustible aerosol provision device 100 comprises a non-combustible aerosol-provision device having a housing 101 comprising an area 102 102 for receiving an article 1.

The area 102 is arranged to receive the article 1. When the article 1 is received into the area 102, at least a portion of the aerosol-generating material 3 comes into thermal proximity with the heater 103. When the article 1 is fully received in the area 102, at least a portion of the aerosol-generating material 3 may be in direct, or indirect, contact with the heater 103. The aerosol-forming material 3 will release a range of volatile compounds at different temperatures. By controlling the maximum operation temperature of the electrically heated aerosol generating system 100, the selective release of undesirable compounds may be controlled by preventing the release of select volatile compounds.

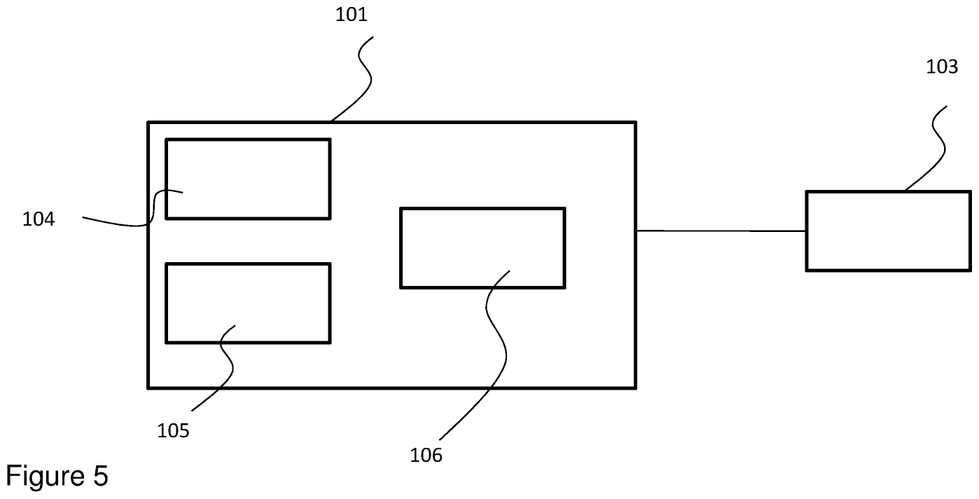

As shown in FIG. 5, within the housing 101 there is an electrical energy supply 104, for example a rechargeable lithium ion battery. A controller 105 is connected to the heater 103, the electrical energy supply 104, and a user interface 106, for example a button or display. The controller 105 controls the power supplied to the heater 103 in order to regulate its temperature. Typically, the aerosol-forming substrate is heated to a temperature of between 250 and 450 degrees centigrade.

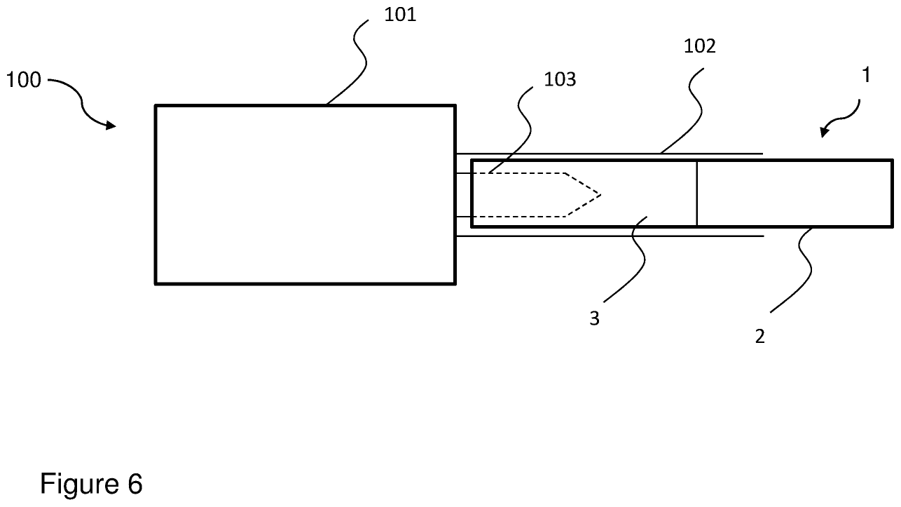

FIG. 6 is a schematic cross-section of a non-combustible aerosol-provision device 100 of the type shown in FIG. 4, with the heater 103 inserted into the aerosol-generating material 3 of an article 1. The non-combustible aerosol provision device 100 is illustrated in engagement with the aerosol-generating article 1 for consumption of the aerosol-generating article 1 by a user.

The housing 101 of non-combustible aerosol provision device 100 defines an area 102 in the form of a cavity, open at the proximal end (or mouth end), for receiving an aerosol-generating article 1 for consumption. The distal end of the cavity is spanned by a heating assembly comprising a heater 103. The heater 103 is retained by a heater mount (not shown) such that an active heating area of the heater is located within the cavity. The active heating area of the heater 103 is positioned within the aerosol-generating section of the aerosol-generating article 1 when the aerosol-generating article 1 is fully received within the cavity.

The heater 103 is configured for insertion into the aerosol generating material 3. As the article 1 is pushed into the device 100, the tapered point of the heater 103 engages with the aerosol-generating material 3. By applying a force to the article 1, the heater 103 penetrates into the aerosol-generating material 3. When the article 1 is properly engaged with the non-combustible aerosol provision device 100, the heater 103 is inserted into the aerosol-generating material 3. When the heater 103 is actuated, aerosol-generating material 3 is warmed and volatile substances are generated or evolved. As a user draws on the mouthpiece 2, air is drawn into the article 1 and the volatile substances condense to form an inhalable aerosol. This aerosol passes through the mouthpiece 2 of the article 1 and into the user's mouth.

Another embodiment of a non-combustible aerosol-provision device 200 according to an embodiment of the invention is shown in FIG. 7, which also shows the components of an embodiment of a non-combustible aerosol provision device 200 in a simplified manner.

As shown in FIG. 7, the non-combustible aerosol provision device 200 comprises a non-combustible aerosol-provision device having a housing 201 comprising an area 202 for receiving an article 1.

In this embodiment, the heating element 103 is omitted. Instead, the device 200 has a varying magnetic field generator 203 surrounding the area 202 into which the article 1 of FIG. 2 is inserted, i.e. an article 1 that incorporates a material layer or liner that forms a heating element 30, as described in more detail below. The control of the device 200 is similar to the control described above in relation to FIG. 5, except that the heater 103 is replaced with a varying magnetic field generator 203.

Irrespective of the composition of the aerosol-generating material 3, embodiments of the invention provide an aerosol-generating material 3 having a cavity 20 that extends in a longitudinal direction from the distal end D in a direction towards the proximal end P so that, when the article 1 is inserted into a first embodiment of a device 100, as shown in FIGS. 4 to 6, the heating element 103 of the device 100 is received in the cavity 20.

In some embodiments, the cavity 20 is coaxial with the longitudinal axis X-X′ of the article and the aerosol-generating material 3 may be tubular in shape. In other embodiments, the cavity 20 may be offset from the longitudinal axis X-X′, and/or comprise multiple cavities 20, one or more of which may receive a heating element 103 when the article 1 is inserted into a device 100.

The cavity may extend for the entire length of the aerosol-generating material 3. Alternatively, the cavity 20 may extend for part of the length of the aerosol-generating material 3.

Although the cavity 20 may have a circular cross-section, as shown in the cross-sectional view of FIG. 2a, other cross-sections are possible. For example, the cross-section of a cavity 20 may be in the shape of a slot, as shown in FIG. 2b, or be star-shaped, as shown in FIG. 2c. It may also have some other non-circular cross-section. In these embodiments, the heating element 103 can be cylindrical, i.e. in the form of a pin, to avoid having to orientate the heating element 103 and the cavity 20 with each other prior to insertion. However, it is possible that the heating element 103 and the cavity 20 may both have the same cross-sectional shape.

Irrespective of the shape of the cavity 20, and irrespective of whether the cavity 20 and the heater 103 have the same cross-sectional shape, the heater 103 may be a snug or interference fit in the cavity 20. In certain embodiments, the heater 103 may have a size which is slightly larger than that of the cavity 20 so that the aerosol-generating material 3 is compressed or deformed by the heater 103 during insertion into the device 100.

In any embodiments of the invention, the inner wall 21a of the cavity 20 of the aerosol-generating material 3 may be coated, lined or otherwise bounded by a layer of a material 30 different to the aerosol-generating material (FIGS. 2d to f). For example, an amorphous solid, and/or a gel and/or a sheet material layer such as paper, or another layer of aerosol-generating material different to the first, may be disposed on, against, or in the vicinity of the inner wall 21a within the cavity 20. The cavity in the aerosol-generating material 3 therefore extends through this second material layer 30. The inner material layer 30 may have a lower coefficient of friction compared to the aerosol-generating material so that the heating element 103 slides into the cavity 20 more easily.

In some embodiments of the invention, the heater 103 and the cavity 20 into which it is inserted have different cross-sections so that the heating element 103 does not entirely fill the cavity 20, leaving a passage or passages for the flow of aerosol between the inner wall 21 of the aerosol-generating material 3 and the heating element 103. By controlling the size of the passage in relation to the size of the heating element 103, the resistance to draw through the aerosol-generating material 3 can be controlled, and optimised, for a particular product or market.

In some embodiments, the passage for the flow of aerosol is formed as an integral part of the cavity 20 in which the heating element 103 is received. In particular, the heating element 103 and the cavity 20 are of different cross-sectional shapes, to form passages between the heating element 103 and the inner wall of the aerosol-generating material 3.

In any of the embodiments of the invention, the cavity 20 in the aerosol-generating material 3 may not be uniform along its length. For example, the shape of the cavity 20 may differ along the length of the aerosol-generating material 3, or the cavity 20 may taper. For example, the cavity 20 may narrow in a direction extending away from the distal end of the aerosol-generating material 3.

Reference to the cavity 20 of the aerosol-generating material 3 as being lined or coated has already been made above. A particular embodiment incorporating a lined cavity 20 is shown in FIG. 1b. In this embodiment, the cavity 20 is lined with a heating element 30 that forms an integral part of the article 1. An article 1 according to FIG. 1b can still be used with the device described with reference to FIGS. 4 to 6, in which the heating element 103 in received in the cavity 20, so that heat is transferred or conducted into the aerosol-generating material 3 from the heater 103 via the heating element 30 which may be in contact with one or both of the aerosol-generating material 3 and the heater 103. However, the article 1 of FIG. 2 may also be used with the device 200 described with reference to FIG. 7, which comprises a varying magnetic field generator 203 for inductively heating the heating element 30 lining the cavity 20 in the aerosol-generating material 3.

As shown in FIG. 3, and irrespective of the type of device 100, 200 that is to be used with the article 1, the lined cavity 20 in the aerosol-generating material 3 may have a circular cross-section, as shown in FIG. 2a, or it may be slot-shaped, as shown in FIG. 2b, or it may be star-shaped, as shown in FIG. 3c. Alternatively, it may have any other regular or irregular shape. In each of these embodiments, the material layer 30 that lines the cavity 20 is shaped to correspond to the shape of the cavity 20.

The heating element 30 lining the cavity 20 is made from an electrically conductive, and may be magnetic, material. It can be made from a ferrous material. Ideally, it is made from a material that enables it to be inductively heated in response to the generation of a varying magnetic field in its vicinity.

The heating element 30 may be permeable. For example, it may be perforated, formed from a mesh or have openings in it to allow for the passage of air and aerosol through the heating element 30. In other embodiments it may be formed from a sheet of impermeable material. The heating element 30 may be formed from a single component or a plurality of components. For example, it could be formed from a plurality of discrete sections separated from each other in a longitudinal direction.

In any embodiment according to the invention, the aerosol-generating material 3 may be extruded through a die. In this manufacturing method, the die can be provided with a mandrel over which the aerosol-generating material 3 is extruded, in order to form the cavity 20 in the aerosol-generating material 3. The mandrel may be cylindrical, but it can have other shapes or configurations to form the required cross-sectional shape cavity within the aerosol-generating material 3.

If the cavity 20 is lined with a material layer 30, then the material layer 30 may be formed into a tube and drawn or otherwise fed over the mandrel as the aerosol-generating material 3 is extruded over it.

In another embodiment, manufacture of the article 1 incorporating a material layer 30 lining the cavity 20 may comprise the steps of forming an aerosol-generating section shown in FIG. 8. In step (a), a sheet 30a of the material that forms the material layer 30 is lowered onto and pressed into, a mold 40, as shown by the arrows in FIG. 8(a). The mold 40 defines the required tubular shape of the aerosol-generating section and has a cylindrical inner surface with a coaxially upstanding former 40a in the shape of the cavity 20. The sheet 30a is pressed into the mold 40 so that it conforms to the mold shape, as shown in FIG. 8(b). Next, the lined mold is filled with aerosol-generating material 3, as shown in FIG. 8(c). The aerosol-generating material 3 may be pressed or stamped into the mold prior to releasing the article 1 from the mold. As shown in FIG. 8(d), the aerosol-generating section comprises the shaped material layer 30 containing the aerosol-generating material 3, and in which the shaped material layer lines the cavity but also wraps around one end of the article 1 and extend over its outer surface.

To finish the aerosol generating section, the end of the article 1 covered with the material layer 30 is cut off (along line C-C in FIG. 8d, so that the material layer 30 lining the cavity 20 is separated from the sheet of material 30a forming an outer layer or wrap that surrounds the aerosol-generating material 3, to form the aerosol-generating section shown in FIG. 8e.

In a further variation, the mold 40 may not have an upstanding former, and the method may include filling the mold with aerosol-generating material 3, once the mold has been lined with the material layer 30. The mold is subsequently spun to generate sufficient centrifugal force to urge the aerosol-generating material 3 against the material layer 30a around the outside of the mold and thereby form a central cavity 20 in the aerosol-generating material 3.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. An article for use in an aerosol provision system, the article comprising a rod of aerosol generating material having a distal end, and a cavity that extends into the rod of aerosol generating material from said distal end.

2. An article according to claim 1, wherein the cavity has a longitudinal axis that is coaxial with a longitudinal axis of the rod of aerosol-generating material.

3. An article according to claim 1 or 2, wherein the cavity extends the full length of the rod aerosol-generating material.

4. An article according to claim 1 or 2, wherein the cavity has a non-circular cross-section.

5. An article according to claim 1 or 2, wherein the cavity has a non-uniform cross section in a longitudinal direction of the aerosol-generating material.

6. An article according to claim 5, wherein the cavity is tapered in a longitudinal direction.

7. An article according to claim 6, wherein the cavity tapers in a direction away from the distal end.

8. An article according to claim 1 or 2, comprising a material layer that lines at least a portion of the cavity.

9. An article according to claim 8, wherein aerosol-generating material is disposed on both surfaces of the material layer such that the material layer is embedded in aerosol-generating material.

10. An article according to claim 8, wherein the material layer is a gel, an amorphous solid, or a sheet material such as paper.

11. An article according to claim 8, wherein the material layer comprises a heating element.

12. An article according to claim 11, wherein the material layer is configured to be conductively, or inductively, heated.

13. An article according to claim 8, wherein the material layer is permeable to air.

14. An article according to claim 13, wherein the material layer is a mesh, is perforated or has openings.

15. An article according to claim 1 or 2, comprising a mouth end opposite to said distal end, said mouth end being configured to be placed between the lips of a user when the distal end is inserted into a non-combustible aerosol provision device.

16. An article according to claim 15, wherein a cooling segment is located between the aerosol-generating material and the mouth end.

17. An article according to claim 16, wherein a filtration segment is located between the cooling segment and the mouth end.

18. A system comprising a non-combustible aerosol provision device, and an article comprising a rod of aerosol-generating material having a distal end for insertion into the non-combustible aerosol provision device, wherein a cavity extends into the rod of aerosol-generating material from said distal end.

19. A system according to claim 18, wherein the article comprises a material layer that lines at least a portion of the cavity.

20. A system according to claim 19, wherein aerosol-generating material is disposed on both surfaces of the material layer such that the material layer is embedded in aerosol-generating material.

21. A system according to claim 19 or 20, wherein the material layer is a gel, an amorphous solid, or a sheet such as paper.

22. A system according to claim 19 or 20, wherein the material layer comprises a heating element.

23. A system according to claim 22, wherein the aerosol-provision device comprises a heater configured so that it extends into the cavity in the rod of aerosol-generating material through said distal end when the article is received in the aerosol-provision device.

24. A system according to claim 23, wherein the heating element and the cavity each have the same cross-sectional shape.

25. A system according to claim 23, wherein the heating element is a snug or interference fit in the cavity.

26. A system according to claim 22, wherein the heating element is a susceptor and the aerosol-provision device comprises a magnetic field generator that surrounds the aerosol-generating material when the article is inserted into the device to inductively heat the heating element.

27. A system according to claim 19 or 20, wherein the material layer is permeable to air.

28. A system according to claim 27, wherein the material layer is a mesh, is perforated or has openings.

29. A method of manufacturing an article comprising a rod of aerosol-generating material having a distal end for insertion into a non-combustible aerosol provision device, the method comprising extruding the aerosol-generating material through a die head and over a mandrel to form a cavity extending through the aerosol-generating material.

30. A method according to claim 29, wherein the mandrel is shaped to provide a correspondingly shaped cavity in the aerosol-generating material.

31. A method according to claim 29 or claim 30, wherein a material layer is drawn over the mandrel and the aerosol-generating material is extruded over the material layer.

32. A method of manufacturing an aerosol-generating section of an article for use in a aerosol-provision system, the aerosol-generating section comprising a rod of aerosol generating material wrapped in a material layer and comprising a cavity lined with a material layer, the method comprising:
providing a material layer sheet;
pressing the material layer sheet into a mould in the shape of an aerosol-generating section including an upstanding former, so that the material layer sheet conforms to the shape of the mould and surrounds the former;
filling the mould with aerosol generating material,
pressing the aerosol-generating material into the mould to form the aerosol-generating section, and
releasing the aerosol-generating section from the mould.

33. A method according to claim 32, comprising cutting an end of the article to separate the material layer wrapping the article from the material layer lining the cavity.

34. A method of manufacturing an aerosol-generating section of an article for use in an aerosol-provision system, the aerosol-generating section comprising a rod of aerosol generating material wrapped in a material layer and comprising a cavity, the method comprising:
providing a material layer sheet;
pressing the material layer sheet into a mould in the shape of an aerosol-generating article so that the material layer sheet conforms to the shape of the mould;
filling the mould with aerosol generating material,
spinning the mould to generate centrifugal force sufficient to urge the aerosol-generating material radially outward and against an inner wall of the mould to form a central cavity, and
releasing the article from the mould.
